(19) United States
(12) Patent Application Publication
(10) Pub. No.: US 2026/0279305 A1
(43) Pub. Date: Sep. 17, 2026

(54) CUSTOMIZABLE CHARGE STATUS INDICATOR SYSTEMS

(71) Applicant: FORD GLOBAL TECHNOLOGIES, LLC, Dearborn, MI (US)

(72) Inventors: Stuart C. Salter, White Lake, MI (US); Jeff Robert Seaman, Petersburg, MI (US); Dawn Piechocki, Gross Pointe Park, MI (US); Nadir Malik, Plymouth, MI (US); Andrew Joseph Daehn, Dearborn, MI (US); Michael Terrence Zitkovic, JR., Dearborn, MI (US)

(21) Appl. No.: 19/079,640

(22) Filed: Mar. 14, 2025

(51) Int. Cl. G09G 5/00

(52) U.S. Cl. CPC G09G 5/003

(57) ABSTRACT

Customizable charge status indicator systems are provided for electrified vehicle charge port assemblies. An exemplary charge status indicator system may include a charge port lighting module and a removable insert panel that can be secured over the charge port lighting module. The removable insert panel may include a customized feature for personalizing the charge status indicator system. The charge port lighting module may be configured to produce lighting effects for indicating a charge status of the vehicle, and these lighting effects may be synchronized with sounds provided by an acoustic vehicle alerting system (AVAS) and/or with additional lighting effects provided by a vehicle lighting system.

### TECHNICAL FIELD

This disclosure relates to electrified vehicles, and more particularly to customizable charge status indicator systems for electrified vehicle charge port assemblies.

### BACKGROUND

Some electrified vehicles, such as plug-in hybrid electric vehicles (PHEVs) and battery electric vehicles (BEVs), include a charge port that is connectable to a charger for charging the vehicle's traction battery pack. The charge port may include an indicator for indicating a charge status (e.g., ready to charge, charging, charge fault, etc.).

### SUMMARY

A charge status indicator system according to an exemplary aspect of the present disclosure includes, among other things, a charge port lighting module, and an insert panel removably positionable relative to the charge port lighting module. The insert panel includes a customized feature that provides a customized styling accent to the charge status indicator system.

In a further non-limiting embodiment of the foregoing charge status indicator system, the charge port lighting module includes one or more plastic indicator lenses, one or more light sources, and a printed circuit board (PCB).

In a further non-limiting embodiment of either of the foregoing charge status indicator systems, the customized feature of the insert panel is positioned over the one or more plastic indicator lenses.

In a further non-limiting embodiment of any of the foregoing charge status indicator systems, the one or more light sources is a multi-colored light emitting diode (LED).

In a further non-limiting embodiment of any of the foregoing charge status indicator systems, the customized feature is a void formed through the insert panel.

In a further non-limiting embodiment of any of the foregoing charge status indicator systems, the customized feature is an insert attached within a window of the insert panel.

In a further non-limiting embodiment of any of the foregoing charge status indicator systems, the customized feature includes a desired geometric shape.

In a further non-limiting embodiment of any of the foregoing charge status indicator systems, the customized feature includes a logo or a symbol.

In a further non-limiting embodiment of any of the foregoing charge status indicator systems, the customized feature includes a vehicle silhouette.

In a further non-limiting embodiment of any of the foregoing charge status indicator systems, the customized feature includes a brand name.

In a further non-limiting embodiment of any of the foregoing charge status indicator systems, the customized feature includes a word, a phrase, or an advertisement.

In a further non-limiting embodiment of any of the foregoing charge status indicator systems, the customized feature is arranged to be selectively illuminated by the charge port lighting module for providing the customized styling accent.

An electrified vehicle according to another exemplary aspect of the present disclosure includes, among other things, a charge port assembly including a port, a charge status indicator system including a lighting module located near the port, and an insert panel removably positionable over the lighting module and including a customized feature for customizing or personalizing the charge port assembly.

In a further non-limiting embodiment of the foregoing electrified vehicle, a controller is programmed to control the lighting module to selectively emit a lighting effect that illuminates the customized feature.

In a further non-limiting embodiment of either of the foregoing electrified vehicles, a panel exciter is configured to emit an audio signal that is synchronized to the lighting effect.

In a further non-limiting embodiment of any of the foregoing electrified vehicles, a lighting device is configured to emit a second lighting effect that is synchronized to the lighting effect emitted by the lighting module.

In a further non-limiting embodiment of any of the foregoing electrified vehicles, the lighting device is a puddle lamp or an illuminated badge.

In a further non-limiting embodiment of any of the foregoing electrified vehicles, a human machine interface (HMI) includes a user interface configured to receive an input of a desired customization of the lighting effect.

In a further non-limiting embodiment of any of the foregoing electrified vehicles, the customized feature is a void formed through the insert panel.

In a further non-limiting embodiment of any of the foregoing electrified vehicles, the customized feature is an insert attached within a window of the insert panel.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a side view of an electrified vehicle equipped with a charge port assembly.

FIG. 2 is a blown-up view of the charge port assembly of the electrified vehicle of FIG. 1.

FIG. 3 schematically illustrates an exemplary charge status indicator system of a vehicle charge port assembly.

FIG. 4 illustrates an exemplary removable insert panel of the charge status indicator system of FIG. 3.

FIG. 5 illustrates another exemplary removable insert panel for a charge status indicator system.

FIG. 6 illustrates another exemplary removable insert panel for a charge status indicator system.

FIG. 7 illustrates another exemplary removable insert panel for a charge status indicator system.

FIG. 8 illustrates another exemplary removable insert panel for a charge status indicator system.

FIG. 9 illustrates yet another exemplary removable insert panel for a charge status indicator system.

FIG. 10 schematically illustrates additional features of a charge status indicator system.

FIG. 11 schematically illustrates additional features of a charge status indicator system.

### DETAILED DESCRIPTION

This disclosure describes customizable charge status indicator systems for electrified vehicle charge port assemblies. An exemplary charge status indicator system may include a charge port lighting module and a removable insert panel that can be secured over the charge port lighting module. The removable insert panel may include one or more customized features for personalizing the charge status indicator system. The charge port lighting module may be configured to produce lighting effects for indicating a charge status of the vehicle, and these lighting effects may be synchronized with sounds provided by an acoustic vehicle alerting system (AVAS) and/or with additional lighting effects provided by a vehicle lighting system. These and other features of this disclosure are discussed in greater detail in the following paragraphs of this detailed description.

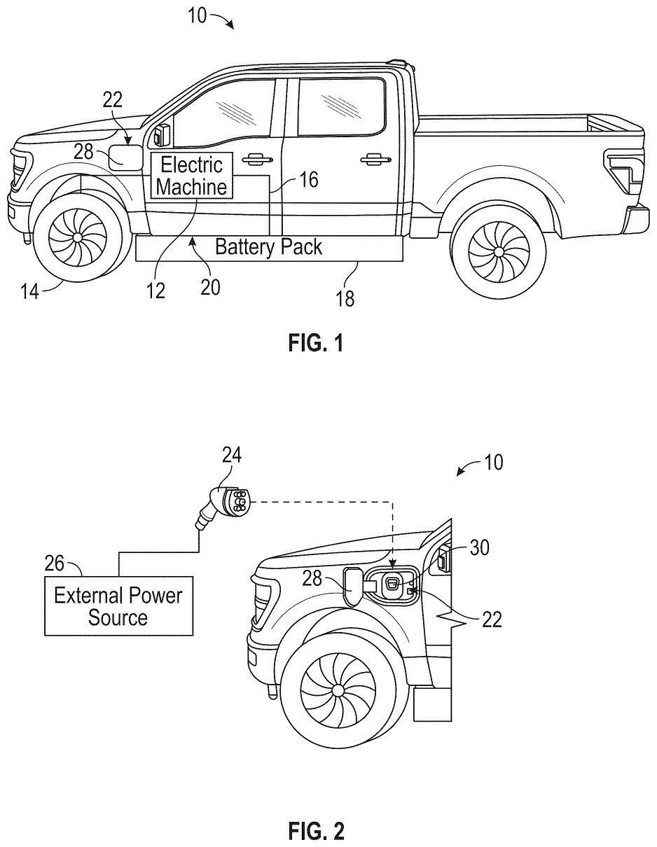

FIGS. 1 and 2 schematically illustrate an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure

The energy storage devices (e.g., battery cells) of the traction battery pack 18 must be periodically recharged in order to replenish the energy level of the traction battery pack 18. The electrified vehicle 10 may include a charge port assembly 22 (sometimes referred to as a vehicle inlet assembly) for charging the energy storage devices of the traction battery pack 18. A charger 24 (sometimes referred to as electric vehicle supply equipment (EVSE)) can be coupled to one or more ports 30 of the charge port assembly 22 in order to charge the traction battery pack 18.

In an embodiment, the charge port assembly 22 is a North American Charging System (NACS) charge port. However, the teachings of this disclosure could be applicable to any type of vehicle charge port.

The traction battery pack 18 may be charged using energy supplied from an external power source 26. The external power source 26 may include utility grid power, solar power, wind power, etc., or any combination of utility grid power and alternative energy sources. The external power source 26 may be located at a home of the user, a public charging station, etc. The ports 30 are configured to receive power (alternating current, direct current, or both) from the external power source 26 through the charger 24.

The charge port assembly 22 may include a charge port door 28 that is typically closed during operation of the electrified vehicle 10. When charging the electrified vehicle 10 from the external power source 26 is desired, the charge port door 28 can be moved from the closed position of FIG. 1 to the open position of FIG. 2. A user can then couple the charger 24 to the port(s) 30 of the charge port assembly 22 so that power from the external power source 26 can be provided to the traction battery pack 18 of the electrified vehicle 10 for charging the battery cells contained therein.

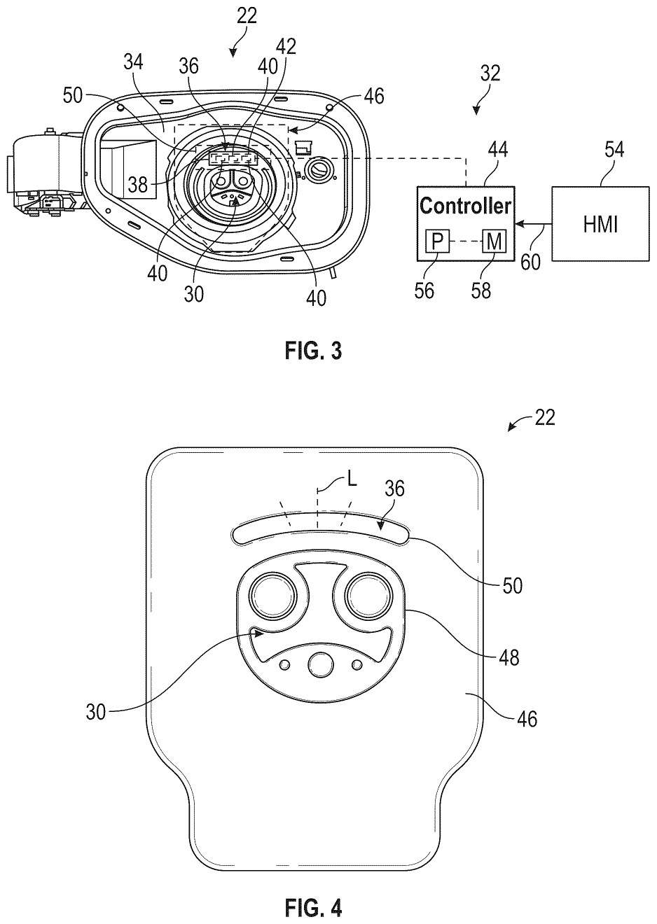

Referring to FIGS. 3-4, with continued reference to FIGS. 1 and 2, the charge port assembly 22 may additionally include a housing 34 and a charge status indicator system 32 for indicating a current charge status of the electrified vehicle 10 during a charging event. The housing 34 may be of any suitable size and shape and therefore its specific configuration is not intended to limit this disclosure. The charge status indicator system 32 may be configured for conveying various charging-related information (e.g., ready to charge, charging, charge fault, etc.) to a user of the electrified vehicle 10.

The charge status indicator system 32 may include a lighting module 36 that is mounted to the housing 34 at a location adjacent to the port 30. In an embodiment, the lighting module 36 is located slightly above the port 30. However, the lighting module 36 could be positioned at any location of the housing 34 that is near the port 30.

The lighting module 36 may include one or more plastic indicator lenses 38, one or more light sources 40, and a printed circuit board (PCB) 42. The plastic indicator lenses 38 may be light permeable to allow light L (schematically shown in FIG. 4) from the light source(s) 40 to escape from the inside to the outside of the lighting module 36 for conveying various charging-related information to the user.

Each light source 40 may be a light emitting diode (LED). In an embodiment, each light source 40 is a multi-colored LED, such as a Red, Green, Blue (RGB) LED, for example. Other light sources could also be utilized within the scope of this disclosure.

The light source(s) 40 may be arranged on the PCB 42, which may be disposed inside the housing 34 of the charge port assembly 22. The PCB 42 of lighting module 36 may be operably connected to a controller 44 of the charge status indicator system 32 and can include control circuitry including LED driver circuitry for controlling activation and deactivation of the light source(s) 40 in response to commands from the controller 44.

The total number of plastic indicator lenses 38 and light sources 40 provided within the lighting module 36 could vary and is thus design dependent. In an embodiment, the lighting module 36 includes a sufficient number of light sources 40 for allowing users to visualize a combination of lighting effects emitted therefrom during both daytime and nighttime ambient conditions.

An insert panel 46 may be removably positioned over the lighting module 36 in order to allow a user to customize the charge status indicator system 32 of the charge port assembly 22 to his/her own individual styling preferences. In an embodiment, the insert panel 46 is positioned directly over the plastic indicator lens 38 of the lighting module 36. The size, shape, color, and overall configuration of the insert panel 46 could vary and are thus not intended to limit this disclosure.

The insert panel 46 may be secured into position relative to the housing 34 of the charge port assembly 22 in any known manner. In an embodiment, the insert panel 46 may include an opening 48 for accommodating the port 30 as the insert panel 46 is moved into engagement with the housing 34. When the insert panel 46 is secured in place relative to the housing 34, the opening 48 may either completely circumscribe the port 30 or could be configured to only partially circumscribe the port 30.

The insert panel 46 may include a customized feature 50. The customized feature may formed in or attached to a body of the insert panel 46. When the insert panel 46 is secured in place relative to the housing 34, the customized feature 50 is positioned directly in front of the plastic indicator lens 38 and can therefore be illuminated by the light L being emitted by the light source(s) 40 of the lighting module 36 when being controlled to convey charging-related information to the user. The customized features can therefore provide a unique, customized styling accent to the charge port assembly 22.

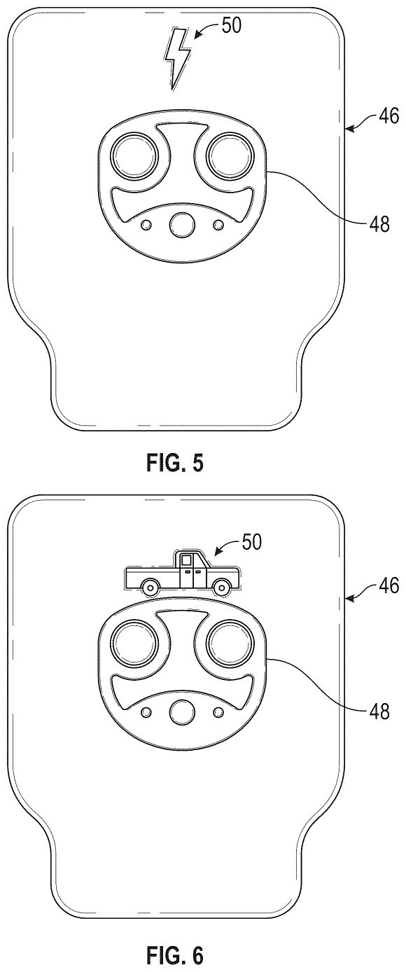

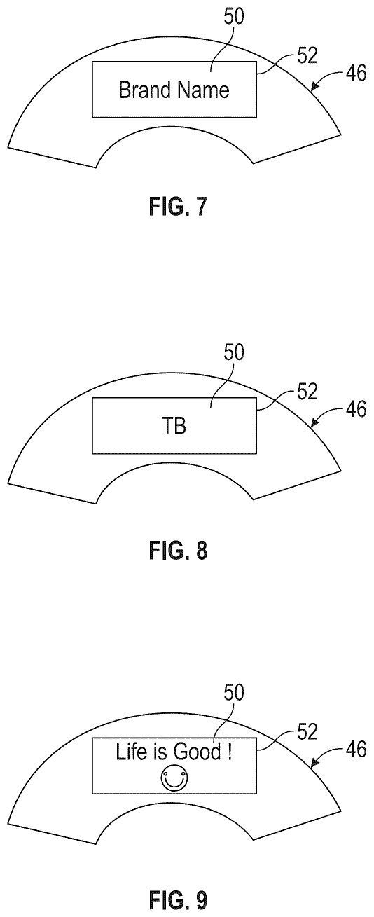

The customized feature 50 may include any design or feature that allows the user to customize or personalize the charge port assembly 22. For example, the customized feature 50 may include any desired geometric shape (see, e.g., FIG. 4), a logo or symbol (see, e.g., FIG. 5), a vehicle silhouette (see, e.g., FIG. 6), a brand name (see, e.g., FIG. 7), a user's initials (see e.g., FIG. 8), a word, phrase, or advertisement (see, e.g., FIG. 9), etc. Some customized features 50 may be embodied by letters or symbols alone, however, other customized features 50 may include a combination of letters and symbols (see, e.g., FIG. 9).

Any of the insert panels 46 described herein may be removed from the charge port assembly 22 and then replaced with another insert panel 46 having a different customized feature 50 whenever the user desires to do so. The charge status indicator system 32 of the charge port assembly 22 may therefore be customized as desired to meet a given user's individual styling preferences.

In an embodiment, the customized feature 50 is a void formed in the insert panel 46 (see FIGS. 4-6). The void may be a separate opening from the opening 48. In another embodiment, the customized feature 50 is an insert that is mountable within a window 52 of the insert panel 46 (see FIGS. 7-9).

The charge status indicator system 32 may additionally include a human machine interface (HMI) 54 that is operably connected to the controller 44. The controller 44 may receive various inputs (e.g., signals) from the HMI 54 for customizing various aspects of the visually distinctive lighting effects that can be emitted by the lighting module 36 in order to convey various charging-related information (e.g., charging level, charging type, charging faults, charging complete, etc.) to a user. The lighting effects emitted by the lighting module 36 can be customized in terms of color, pattern, brightness, speed of illumination, length of illumination, etc.

The controller 44 can selectively activate each light source 40 of the lighting module 36 to cause the light sources 40 to emit light through the plastic indicator lenses 38 and onto the customized feature 50 of the insert panel 46 for conveying customized charging-related information to the user. In an embodiment, the controller 44 is a local interconnect network (LIN) microcontroller. LIN is a communication protocol utilized to communicate between components of vehicles. The LIN protocol can communicate utilizing LIN messages (signals). In an embodiment, the controller 44 can transmit LIN messages along multiple paths to activate or deactivate the light sources 40.

The controller 44 may include a processing unit 56 and non-transitory memory 58 for executing the various control strategies of the charge status indicator system 32. The processing unit 56 can be programmed to execute one or more programs stored in the memory 58. The program may be stored in the memory 58 as software code, for example. The program stored in the memory 58 may include one or more additional or separate programs, each of which includes an ordered list of executable instructions for implementing logical functions associated with the charge status indicator system 32.

The processing unit 56 can be a custom made or commercially available processor, a central processing unit (CPU), or generally any device for executing software instructions. The memory 58 can include any one or combination of volatile memory elements and/or nonvolatile memory elements.

The HMI 54 may be accessible for use from within a passenger cabin of the electrified vehicle 10. Alternatively or additionally, the HMI 54 could be presented within a mobile application on a smart device (e.g., smart phone, etc.) of the user. The HMI 54 may include various user interfaces for allowing the vehicle user to enter information into the HMI 54. The user may interact with the user interfaces via various touch screens, tactile buttons, audible speech, speech synthesis, etc., or any combination of such input devices.

In an embodiment, the HMI 54 enables the user to customize various settings associated with the charge status indicator system 32. For example, the user may customize, via the HMI 54, features such as color, pattern, brightness, speed of illumination, length of illumination, etc. of the various lighting effects that can be emitted by the lighting module 36 of the charge status indicator system 32. When the user has customized a particular setting associated with the charge status indicator system 32 using the HMI 54, the HMI 54 may communicate an input signal 60 to the controller 44. In response to receiving the input signal 60, the controller 44 may subsequently command the lighting module 36 to apply a custom color, pattern, etc. to a lighting effect that is be emitted during a subsequent charging event (e.g., when the charger 24 is next plugged into the port 30 of the charge port assembly 22). Each light source 40 of the lighting module 36 can be selectively controlled, either individually or in units, to generate the requested customized color, pattern, etc. to be emitted by the lighting module 36.

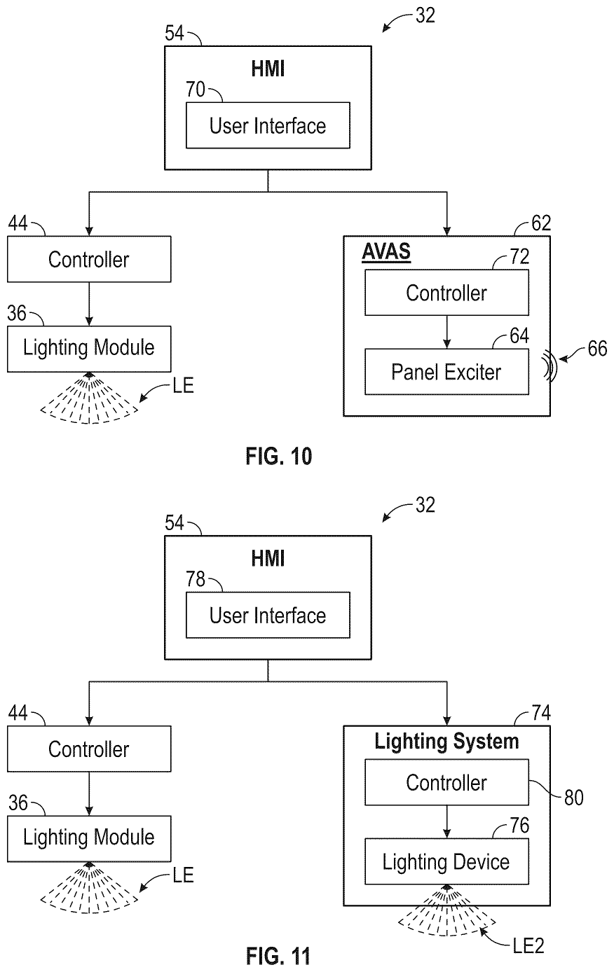

Referring to FIG. 10, the lighting effects produced by the charge status indicator system 32 for indicating a charge status during a charging event of the electrified vehicle 10 may be synchronized with or otherwise coordinated to one or more sounds that can be produced by an acoustic vehicle alerting system (AVAS) 62. The AVAS 62 may include one or more panel exciters 64 (e.g., vibration exciters) that are configured to selectively broadcast audio signals 66 about the exterior of the electrified vehicle 10 by vibrating corresponding portions of a vehicle body panel to which the panel exciter 64 is mounted. The audio signals 66 broadcast by the panel exciter 64 may include a word or phrase, a chime or other sound effect, a series of sounds effects, a song, or any combination of words and sounds effects, for example.

Once synchronized/coordinated to the charge status indicator system 32, the AVAS 62 may continuously or intermittently emit different audio signals 66 for indicating each different type of charging status. The audio signals 66 emitted by the AVAS 62 may also be coordinated to specific colors of the light emitted by the lighting module 36 of the charge status indicator system 32. The AVAS 62 may also be programmed to vary the volume and/or type of the audio signals 66 emitted therefrom based on a current state of charge of the traction battery pack 18, the distance an authorized user is from the electrified vehicle 10 when approaching, etc.

The HMI 54 may include a user interface 70 configured for allowing the user to synchronize the lighting effects LE emitted by the charge status indicator system 32 to the audio signals 66 emitted by the AVAS 62 during charging events. When a charging event is detected, the HMI 54 may communicate with the controller 44 of the charge status indicator system 32 and a controller 72 of the AVAS 62 for carrying out the coordinated lighting and sound effects that have been selected by the user.

Referring to FIG. 11, the lighting effects LE produced by the charge status indicator system 32 for indicating a charge status during a charging event of the electrified vehicle 10 may be synchronized with or otherwise coordinated to one or more lighting effects LE2 that can be produced by a vehicle lighting system 74. The vehicle lighting system 74 may include one or more lighting devices 76 (e.g., a puddle lamp, an illuminated badge, frunk lights, etc.) that are configured to emit light in and/or around the electrified vehicle 10.

Each lighting device 76 may be capable of producing various lighting effects LE2 similar to those that can be emitted by the lighting module 36 of the charge status indicator system 32. Once the vehicle lighting system 74 is synchronized to the charge status indicator system 32, one or more of the lighting devices 76 of the vehicle lighting system 74 may emit lighting effects LE2 that are coordinated with the lighting effects LE of the lighting module 36 for indicating each different type of charging status.

The HMI 54 may include a user interface 78 configured for allowing the user to synchronize the lighting effects LE emitted by the charge status indicator system 32 with the lighting effects LE2 emitted by the lighting device(s) 76 during charging events. When a charging event is detected, the HMI 54 may communicate with the controller 44 of the charge status indicator system 32 and a controller 80 of the vehicle lighting system 74 for carrying out the coordinated lighting effects that have been selected by the user.

The charge status indicator systems of this disclosure can allow for user-by-user customization by removably connecting insert panels that provide a customized feature to the charge port. The ability to customize the charge port in this manner can be beneficial to customers who find default charge status indication settings to be bland and generic.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A charge status indicator system, comprising:
a charge port lighting module; and
an insert panel removably positionable relative to the charge port lighting module,
wherein the insert panel includes a customized feature that provides a customized styling accent to the charge status indicator system.

2. The charge status indicator system as recited in claim 1, wherein the charge port lighting module includes one or more plastic indicator lenses, one or more light sources, and a printed circuit board (PCB).

3. The charge status indicator system as recited in claim 2, wherein the customized feature of the insert panel is positioned over the one or more plastic indicator lenses.

4. The charge status indicator system as recited in claim 2, wherein the one or more light sources is a multi-colored light emitting diode (LED).

5. The charge status indicator system as recited in claim 1, wherein the customized feature is a void formed through the insert panel.

6. The charge status indicator system as recited in claim 1, wherein the customized feature is an insert attached within a window of the insert panel.

7. The charge status indicator system as recited in claim 1, wherein the customized feature includes a desired geometric shape.

8. The charge status indicator system as recited in claim 1, wherein the customized feature includes a logo or a symbol.

9. The charge status indicator system as recited in claim 1, wherein the customized feature includes a vehicle silhouette.

10. The charge status indicator system as recited in claim 1, wherein the customized feature includes a brand name.

11. The charge status indicator system as recited in claim 1, wherein the customized feature includes a word, a phrase, or an advertisement.

12. The charge status indicator system as recited in claim 1, wherein the customized feature is arranged to be selectively illuminated by the charge port lighting module for providing the customized styling accent.

13. An electrified vehicle, comprising:
a charge port assembly including a port;
a charge status indicator system including a lighting module located near the port; and
an insert panel removably positionable over the lighting module and including a customized feature for customizing or personalizing the charge port assembly.

14. The electrified vehicle as recited in claim 13, comprising a controller programmed to control the lighting module to selectively emit a lighting effect that illuminates the customized feature.

15. The electrified vehicle as recited in claim 14, comprising a panel exciter that is configured to emit an audio signal that is synchronized to the lighting effect.

16. The electrified vehicle as recited in claim 14, comprising a lighting device that is configured to emit a second lighting effect that is synchronized to the lighting effect emitted by the lighting module.

17. The electrified vehicle as recited in claim 16, wherein the lighting device is a puddle lamp or an illuminated badge.

18. The electrified vehicle as recited in claim 14, comprising a human machine interface (HMI) that includes a user interface configured to receive an input of a desired customization of the lighting effect.

19. The electrified vehicle as recited in claim 13, wherein the customized feature is a void formed through the insert panel.

20. The electrified vehicle as recited in claim 13, wherein the customized feature is an insert attached within a window of the insert panel.
